(19) United States
(12) Patent Application Publication
(10) Pub. No.: US 2026/0327750 A1
(43) Pub. Date: Oct. 22, 2026

(54) METHOD FOR ENHANCED SEPARATION OF PLURALITY OF METALS FROM HIGH-TIN-CONTENT TIN TAILING AND PREPARATION OF HIGH-QUALITY IRON POWDER

(71) Applicant: Kunming University of Science and Technology, Kunming (CN)

(72) Inventors: Hua Wang, Kunming (CN); Yong Yu, Kunming (CN); Jianhang Hu, Kunming (CN); Cheng Yang, Kunming (CN); Pankun Wang, Kunming (CN); Cheng Tan, Kunming (CN); Ruijin Fan, Kunming (CN); Jinlong Du, Kunming (CN)

(21) Appl. No.: 19/687,688

(22) Filed: May 26, 2026

(30) Foreign Application Priority Data
May 28, 2025 (CN) 202510696299.7

(51) Int. Cl. C22B 25/06; C22B 7/00; C22B 7/02; C22B 13/02; C22B 19/20; C22B 25/02; C22B 30/04

(52) U.S. Cl. CPC C22B 25/06; C22B 7/001; C22B 7/02; C22B 13/025; C22B 19/20; C22B 25/02; C22B 30/04

(57) ABSTRACT

Provided is a method for enhanced separation of metals from a high-tin-content tin tailing and preparation of a high-quality iron powder. The method includes: thoroughly mixing the high-tin-content tin tailing with a first reducing agent to produce a pellet; drying the pellet, and mixing a dried pellet with a second reducing agent; heating to 950 °C to 1,100 °C, and conducting heat preservation for 20 min to 150 min to produce a flue gas and a roasting residue; cooling the flue gas to produce a flue dust including tin, arsenic, lead, and zinc; and subjecting the roasting residue to water cooling, grinding, and then magnetic separation to produce the high-quality iron powder. In this application, volatilization rates of tin, arsenic, lead, and zinc all exceed 90%, an iron grade is greater than 98%, and an iron recovery rate exceeds 75%.

### CROSS-REFERENCE TO RELATED APPLICATIONS

This patent application claims the benefit and priority of Chinese Patent Application No. 202510696299.7 filed with the China National Intellectual Property Administration on May 28, 2025, the disclosure of which is incorporated by reference herein in its entirety as part of the present application.

### TECHNICAL FIELD

The present disclosure relates to a method for enhanced separation of metals from a high-tin-content tin tailing and preparation of a high-quality iron powder, and belongs to the technical field of efficient recycling of metal mineral resources.

### BACKGROUND

Tin is an important strategic resource and an indispensable key rare metal in China. During the development and utilization of tin ore resources, a large quantity of tin tailings have been generated and stockpiled worldwide. Process mineralogy results show that tin tailings typically include components such as iron, arsenic, lead, zinc, and sulfur, and have a tin content of 0.2% to 0.8%. In tin tailings, tin exists primarily in the form of fine-grained cassiterite closely intergrown with iron ore, and exhibits a poor degree of liberation. Through a pretreatment of a tin tailing, tin, iron, arsenic, lead, and zinc can be efficiently enriched, with a tin content enriched to 0.4% to 1.2%. However, a pretreated tin tailing is hardly applicable in the existing tin smelting process.

Treatment processes for low-grade tin resources mainly include a beneficiation process, a beneficiation-metallurgy combined process, and a roasting process. Due to the brittleness and fine dissemination grain size of cassiterite, the beneficiation process often employs the combination of staged grinding with gravity separation, flotation, and magnetic separation. The beneficiation process can upgrade a tin grade to 3% to 40% for reduction smelting in a fuming furnace or Ausmelt furnace. The beneficiation process offers advantages such as low processing cost and simple operation, but also demonstrates disadvantages including low recovery rates of valuable metals, high environmental hazards caused by secondary tailing stockpiling, and relatively low economic benefits. The beneficiation-metallurgy combined process (CN116889925A, Method for recycling tin and iron from tin tailings through classified pre-enrichment and classified separation) employs the combination of classification, gravity separation, and high-intensity magnetic separation to produce tin-iron associated minerals and a high-intensity magnetic separation iron concentrate. The tin-iron associated minerals are subjected to reduction roasting at 650 °C with 10 wt % of an additive to convert Fe₂O₃ into Fe₃O₄. A reduction roasting product is then subjected to magnetic separation to produce an iron concentrate with an iron grade of 61.16% and a comprehensive recovery of 23.00% and a tin-rich middling with a tin grade of 3.53% and a recovery of 67.1%. The high-intensity magnetic separation iron concentrate is subjected to reduction roasting at 700 °C with 15% of lignite and then to grinding and low-intensity magnetic separation, so as to produce an iron concentrate with an iron grade of 60.34% and a comprehensive recovery of 48.02%. Because tin and arsenic tend to form tin/iron and arsenic/iron spinels Feₓ (Sn,As)₃₋ₓO₄ with ferroferric oxide (Fe₃O₄) in a magnetic separation concentrate at a low temperature, the magnetization roasting in the beneficiation-metallurgy combined process cannot achieve efficient separation of tin, arsenic, and iron. As a result, an iron concentrate obtained from tin-arsenic-iron associated minerals includes excessively high levels of tin (higher than 0.3%) and arsenic, and thus cannot be used (the tin content is required to be lower than 0.08% in the steel industry), leading to significant wastage of tin resources. More importantly, the iron concentrate has an iron content of only 60% to 65%, and possesses relatively low economic value. Due to heavy pollution, chlorination roasting is unsuitable for industrial application. Existing roasting processes include reduction roasting and sulfidation roasting. The reduction roasting (CN102965522B, Method for separating and recovering tin from tin-containing mill tailings) is carried out by heating at 850 °C to 1,000 °C under a weakly reducing atmosphere (with a CO volume concentration CO/(CO+CO₂) of 20% to 50%), during which tin in a tailing is reduced and volatilized into a flue gas. However, the reduction roasting is only suitable for tailings with a tin content of less than 0.3%, enables a recovery rate of less than 75%, and does not allow for the recycling of iron. The sulfidation roasting (CN103088181B, Method for obtaining sponge iron by treating high-iron low-tin ore by sulfurizing volatilization direct-reduction process) is carried out by treating high-iron low-tin ore (Sn content: less than 0.4%) at 1,000 °C to 1,300 °C, and leads to sponge iron with an iron content of 90% to 92%. More importantly, when tin and arsenic contents in ore are high, tin and arsenic contents in sponge iron increase significantly, making it difficult to utilize the sponge iron.

In summary, due to the similar physicochemical properties of tin, arsenic, and iron, it is difficult for existing technologies to achieve efficient separation of tin and arsenic from iron in a high-tin-content tin tailing (Sn content: 0.4% to 1.2%). Consequently, tin and arsenic are enriched into an iron product, leading to wastage of tin resources and poor quality, low value, and difficult industrial utilization of the product. Currently, the utilization rate of tin tailings is extremely low. Tin tailings are discarded and stockpiled in open-air tailing ponds, occupying a large quantity of land resources. Moreover, harmful elements such as arsenic, lead, and zinc in tin tailings also contaminate surrounding water, soil, and crops. Therefore, it is urgent to break through the bottleneck of efficient utilization of tin and iron in high-tin-content tin tailings and improve the availability of global tin resources, which is of great significance for the eco-friendly and sustainable development of the tin industry.

### SUMMARY

In order to overcome the problems in the background, an objective of the present disclosure is to provide a method for enhanced separation of metals from a high-tin-content tin tailing and preparation of a high-quality iron powder. The core of the method is based on the different reduction and volatilization characteristics of tin, arsenic, and iron phases. In the present disclosure, key parameters such as coupling, types, mixing ratio, and addition manner of carbonaceous reducing agents, and temperature are regulated such that the volatilization of arsenic and tin occurs before the reduction of FeO into Fe. The method of the present disclosure overcomes the industry challenge of achieving enhanced separation of tin and arsenic from iron and synergistic deep reduction of iron (reduction of FeO into Fe) in a same process, and enables the synchronous recovery of valuable metals such as lead and zinc. A flue dust in which tin, lead, zinc, and arsenic are efficiently enriched can serve as a high-quality tin raw material. Compared with iron concentrate and sponge iron, the metallic iron powder obtained by the method of the present disclosure has a high grade and a low impurity content. Thus, the method of the present disclosure enables high-value utilization of tin tailings and possesses excellent application and promotion potential.

To achieve the above objective, the present disclosure is implemented by the following technical solutions:

A method for enhanced separation of metals from a high-tin-content tin tailing and preparation of a high-quality iron powder is provided, including the following steps:
(1) thoroughly mixing the high-tin-content tin tailing with a first reducing agent to produce a pellet; drying the pellet, and mixing a dried pellet with a second reducing agent; heating to 950 °C to 1,100 °C, and conducting heat preservation for 20 min to 150 min to produce a flue gas and a roasting residue; and cooling the flue gas to produce a flue dust including tin, arsenic, lead, and zinc; and
(2) subjecting the roasting residue to water cooling, grinding, and then magnetic separation to produce the high-quality iron powder.

Preferably, the high-tin-content tin tailing has a tin content of 0.4 wt % to 1.2 wt %, an iron content of 5 wt % to 50 wt %, an arsenic content of 0.1 wt % to 3 wt %, a lead content of 0.1 wt % to 5 wt %, and a zinc content of 0.1 wt % to 5 wt %.

Preferably, a mass ratio of the high-tin-content tin tailing to the first reducing agent is 100:(5-15).

Preferably, the first reducing agent includes a reducing agent A and a reducing agent B. The reducing agent A is a reducing agent exhibiting a carbon dioxide reactivity of more than 25% in a temperature range of 600 °C to 900 °C, such as spent activated carbon, waste engine oil, bio-oil, bituminous coal, or semi-coke, and the reducing agent A has a particle size of less than 150 mesh. The reducing agent B is a reducing agent exhibiting a carbon dioxide reactivity of less than 20% in a temperature range of 900 °C to 1,100 °C, such as petroleum coke, coke, or defluorinated spent cathode carbon from aluminum electrolysis. The reducing agent B includes a coarse fraction with a particle size of 50 mesh to 120 mesh and a fine fraction with a particle size of 200 mesh to 400 mesh, and a mass ratio of the coarse fraction to the fine fraction is (20-70):(80-30).

The carbon dioxide reactivity refers to a chemical reactivity of a carbon material such as coal with carbon dioxide, and is represented by a carbon dioxide reduction rate.

Preferably, a mass ratio of the reducing agent A to the reducing agent B is (5-25):(95-75).

Preferably, the second reducing agent is a reducing agent with a carbon content of greater than 75%, including at least one selected from the group consisting of bituminous coal, semi-coke, petroleum coke, coke, and defluorinated spent cathode carbon from aluminum electrolysis. The second reducing agent has a particle size of 2.5 cm to 200 mesh. A mass ratio of the pellet to the second reducing agent is 100:(5-50).

Preferably, the roasting residue is ground to a particle size of less than 200 mesh, and the magnetic separation is conducted at a magnetic field intensity of 70 kA/m to 140 kA/m.

Preferably, the high-quality iron powder has an iron grade of greater than 98%.

The present disclosure has the following beneficial effects:
(1) The present disclosure provides a simple, efficient, safe, and low-cost method for enhanced separation of metals from a high-tin-content tin tailing and preparation of a high-quality iron powder, which overcomes the industry challenge of efficient separation of tin, lead, and zinc from tin tailings with a tin content of 0.4% to 1.2% coupled with deep reduction of iron. The method of the present disclosure enables a tin recovery rate of higher than 95%, with a significant improvement of 15% to 50% compared to the mainstream beneficiation process. The method of the present disclosure solves the issues of acid-soluble tin and fine, densely intergrown cassiterite that are difficult to address by the mainstream beneficiation process for tin tailings.
(2) The present disclosure adopts a first reducing agent and a second reducing agent in combination with a specified roasting temperature and time to synergistically achieve high-value utilization of iron. With the present disclosure, iron in a high-tin-content tin tailing is deeply reduced into elemental Fe to produce an iron product that has an iron grade of greater than 98% and tin, arsenic, and sulfur impurity contents of less than 0.02%, 0.05%, and 0.05%, respectively, with an iron recovery rate of greater than 80%. The iron product is further subjected to magnetic separation to produce a high-quality iron powder (Fe: higher than 98%), which has significantly higher value than an iron concentrate (Fe: 60% to 70%) produced from traditional iron ore. Moreover, lead, zinc, and arsenic recovery rates of greater than 90% are synergistically achieved, enabling the recovery of associated valuable components and the reduction of harmful components such as arsenic.

### DETAILED DESCRIPTION OF THE EMBODIMENTS

The present disclosure will be further described in detail below in conjunction with specific examples, but the protection scope of the present disclosure is not limited thereto.

### Example 1

A method for enhanced separation of metals from a high-tin-content tin tailing and preparation of a high-quality iron powder was provided, including the following steps:
(1) A high-tin-content tin tailing with the following composition was selected:

TABLE 1
Main chemical composition of the high-tin-content tin tailing

| | Chemical component | | | | | | | | |
|---|---|---|---|---|---|---|---|---|---|
| | Sn | Fe | As | Cu | Pb | Zn | S | CaO | SiO₂ |
| Content/wt. % | 0.81 | 33.89 | 0.81 | 0.03 | 0.98 | 0.89 | 0.21 | 10.93 | 4.75 |

(2) 100 wt % of the high-tin-content tin tailing, 1.5 wt % of semi-coke, and 6.5 wt % of petroleum coke were thoroughly mixed and prepared into a pellet. The pellet was dried. 100 wt % of a dried pellet and 20 wt % of bituminous coal were mixed, heated to 1,050 °C at a heating rate of 20 °C/min, and kept at 1,050 °C for 70 min to produce a flue gas and a roasting residue. The flue gas was cooled to produce a flue dust including tin, arsenic, lead, and zinc.
(3) The roasting residue obtained in the step (2) was water-cooled, ground to −400 mesh, and then subjected to low-intensity magnetic separation (70 kA/m) to produce the high-quality iron powder and a tailing.

The calculated recovery rates of tin, arsenic, lead, and zinc reached 95.41%, 94.26%, 98.21%, and 90.25%, respectively. The high-quality iron powder had an iron grade of 98.15% and corresponded to an iron recovery rate of 77.21%. The tin, arsenic, lead, and zinc impurity contents in the high-quality iron powder were less than 0.02%, 0.05%, 0.03%, and 0.04%, respectively. The results showed that the method enabled the enhanced separation of tin, lead, and zinc from the tin tailing coupled with the high-value reutilization of iron, and also achieved the reduction of arsenic-containing waste. The flue dust including tin, lead, zinc, and arsenic had a tin enrichment ratio of greater than 10, and thus could serve as a high-quality raw material for existing tin smelting processes.

### Example 2

A method for enhanced separation of metals from a high-tin-content tin tailing and preparation of a high-quality iron powder was provided, including the following steps:
(1) 100 wt % of the high-tin-content tin tailing, 1 wt % of bituminous coal, and 8 wt % of coke were thoroughly mixed and prepared into a pellet. The pellet was dried. 100 wt % of a dried pellet and 20 wt % of semi-coke were mixed, heated to 1,000 °C at a heating rate of 30 °C/min, and kept at 1,000 °C for 150 min to produce a flue gas and a roasting residue. The flue gas was cooled to produce a flue dust including tin, arsenic, lead, and zinc.
(2) The roasting residue obtained in the step (1) was water-cooled, ground to −250 mesh, and then subjected to low-intensity magnetic separation (140 kA/m) to produce the high-quality iron powder and a tailing.

The calculated recovery rates of tin, arsenic, lead, and zinc reached 94.12%, 95.14%, 99.11%, and 92.43%, respectively. The high-quality iron powder had an iron grade of 98.01% and corresponded to an iron recovery rate of 82%. The tin, arsenic, lead, and zinc impurity contents in the high-quality iron powder were less than 0.02%, 0.05%, 0.03%, and 0.04%, respectively. The results showed that the method enabled the enhanced separation of tin, lead, and zinc from the tin tailing coupled with the high-value reutilization of iron, and also achieved the reduction of arsenic-containing waste. The flue dust including tin, lead, zinc, and arsenic had a tin enrichment ratio of greater than 10, and thus could serve as a high-quality raw material for existing tin smelting processes.

### Example 3

A method for enhanced separation of metals from a high-tin-content tin tailing and preparation of a high-quality iron powder was provided, including the following steps:
(1) 100 wt % of the high-tin-content tin tailing, 1.1 wt % of bituminous coal, and 13 wt % of coke were thoroughly mixed and prepared into a pellet. The pellet was dried. 100 wt % of a dried pellet and 5 wt % of defluorinated spent cathode carbon from aluminum electrolysis were mixed, heated to 1,100 °C at a heating rate of 5 °C/min, and kept at 1,100 °C for 20 min to produce a flue gas and a roasting residue. The flue gas was cooled to produce a flue dust including tin, arsenic, lead, and zinc.
(2) The roasting residue obtained in the step (1) was water-cooled, ground to −250 mesh, and then subjected to low-intensity magnetic separation (100 kA/m) to produce the high-quality iron powder and a tailing.

The calculated recovery rates of tin, arsenic, lead, and zinc reached 95.44%, 96.12%, 98.86%, and 90.12%, respectively. The high-quality iron powder had an iron grade of 98.75% and corresponded to an iron recovery rate of 84.12%. The tin, arsenic, lead, and zinc impurity contents in the high-quality iron powder were less than 0.02%, 0.03%, 0.02%, and 0.03%, respectively. The results showed that the method enabled the enhanced separation of tin, lead, and zinc from the tin tailing coupled with the high-value reutilization of iron, and also achieved the reduction of arsenic-containing waste. The flue dust including tin, lead, zinc, and arsenic had a tin enrichment ratio of greater than 10, and thus could serve as a high-quality raw material for existing tin smelting processes.

### Comparative Example 1

A method for enhanced separation of metals from a high-tin-content tin tailing and preparation of an iron powder was provided, including the following steps:
(1) 100 wt % of the high-tin-content tin tailing and 10 wt % of petroleum coke were thoroughly mixed and prepared into a pellet. The pellet was dried. 100 wt % of a dried pellet and 20 wt % of bituminous coal were mixed, heated to 1,050 °C at a heating rate of 20 °C/min, and kept at 1,050 °C for 70 min to produce a flue gas and a roasting residue. The flue gas was cooled to produce a flue dust including tin, arsenic, lead, and zinc.
(2) The roasting residue obtained in the step (1) was water-cooled, ground to −400 mesh, and then subjected to low-intensity magnetic separation (70 kA/m) to produce the iron powder and a tailing.

The calculated recovery rates of tin, arsenic, lead, and zinc reached 68.13%, 74.12%, 94.86%, and 87.12%, respectively. The iron powder had an iron grade of 96.05% and corresponded to an iron recovery rate of 78%. The results showed that iron and arsenic could not be efficiently separated from iron, and the iron powder had a declined grade and excessive contents of tin and arsenic impurities and thus could hardly be used.

### Comparative Example 2

A method for enhanced separation of metals from a high-tin-content tin tailing and preparation of an iron powder was provided, including the following steps:
(1) 100 wt % of the high-tin-content tin tailing and 10 wt % of semi-coke were thoroughly mixed and prepared into a pellet. The pellet was dried. 100 wt % of a dried pellet and 20 wt % of bituminous coal were mixed, heated to 1,050 °C at a heating rate of 20 °C/min, and kept at 1,050 °C for 70 min to produce a flue gas and a roasting residue. The flue gas was cooled to produce a flue dust including tin, arsenic, lead, and zinc.
(2) The roasting residue obtained in the step (1) was water-cooled, ground to −400 mesh, and then subjected to low-intensity magnetic separation (70 kA/m) to produce the iron powder and a tailing.

The calculated recovery rates of tin, arsenic, lead, and zinc reached 55.13%, 34.12%, 92.86%, and 85.12%, respectively. The iron powder had an iron grade of 83.14% and corresponded to an iron recovery rate of 72%. The results showed that iron and arsenic could not be efficiently separated from iron, and the iron powder had a declined grade and excessive contents of tin and arsenic impurities and thus could hardly be used.

### Comparative Example 3

A method for enhanced separation of metals from a high-tin-content tin tailing and preparation of an iron powder was provided, including the following steps:
(1) 100 wt % of the high-tin-content tin tailing, 1.5 wt % of semi-coke, and 6.5 wt % of petroleum coke were thoroughly mixed and prepared into a pellet. The pellet was dried. 100 wt % of a dried pellet and 20 wt % of lignite were mixed, heated to 1,050 °C at a heating rate of 20 °C/min, and kept at 1,050 °C for 70 min to produce a flue gas and a roasting residue. The flue gas was cooled to produce a flue dust including tin, arsenic, lead, and zinc.
(2) The roasting residue obtained in the step (1) was water-cooled, ground to −400 mesh, and then subjected to low-intensity magnetic separation (70 kA/m) to produce the iron powder and a tailing.

The calculated recovery rates of tin, arsenic, lead, and zinc reached 92.44%, 91.21%, 94.86%, and 78.21%, respectively. The iron powder had an iron grade of 77.23% and corresponded to an iron recovery rate of 64.12%. However, the flue dust including tin, lead, zinc, and arsenic had a tin enrichment ratio of only 5, significantly reducing the quality of the tin-smelting raw material.

### Comparative Example 4

A method for enhanced separation of metals from a high-tin-content tin tailing and preparation of an iron powder was provided, including the following steps:
(1) 100 wt % of the high-tin-content tin tailing and 30 wt % of bituminous coal were thoroughly mixed and prepared into a pellet. The pellet was dried, heated to 1,050 °C at a heating rate of 20 °C/min, and kept at 1,050 °C for 70 min to produce a flue gas and a roasting residue. The flue gas was cooled to produce a flue dust including tin, arsenic, lead, and zinc.
(2) The roasting residue obtained in the step (1) was water-cooled, ground to −250 mesh, and then subjected to low-intensity magnetic separation (0.3×10⁵ A/m) to produce the iron powder and a tailing.

The calculated recovery rates of tin, arsenic, lead, and zinc reached 51.13%, 38.12%, 93.86%, and 78.12%, respectively. The iron powder had an iron grade of 93.15% and corresponded to an iron recovery rate of 84.12%. Tin and arsenic were inefficiently separated from iron, and the iron powder exhibited poor quality.

Finally, it should be noted that the above preferred embodiments are merely intended to illustrate rather than limit the technical solutions of the present disclosure. Although the present disclosure has been described in detail through the above preferred embodiments, those skilled in the art should appreciate that various changes may be made to the present disclosure in the form and detail without departing from the scope defined by the claims of the present disclosure.

What is claimed is:

1. A method for enhanced separation of metals from a high-tin-content tin tailing and preparation of a high-quality iron powder, comprising following steps:
(1) thoroughly mixing the high-tin-content tin tailing with a first reducing agent to produce a pellet; drying the pellet, and mixing a dried pellet with a second reducing agent; heating to 900 °C to 1,100 °C, and conducting heat preservation for 20 min to 150 min to produce a flue gas and a roasting residue; and cooling the flue gas to produce a flue dust comprising tin, arsenic, lead, and zinc; and
(2) subjecting the roasting residue to water cooling, grinding, and then magnetic separation to produce the high-quality iron powder;
wherein the first reducing agent comprises a reducing agent A and a reducing agent B; the reducing agent A is a reducing agent exhibiting a carbon dioxide reactivity of more than 25% in a temperature range of 600 °C to 900 °C; the reducing agent B is a reducing agent exhibiting a carbon dioxide reactivity of less than 20% in a temperature range of 900 °C to 1,100 °C; a mass ratio of the reducing agent A to the reducing agent B is (5-25):(95-75); and the second reducing agent is a reducing agent with a carbon content of more than 75%, and a mass ratio of the pellet to the second reducing agent is 100:(5-50).

2. The method for enhanced separation of metals from a high-tin-content tin tailing and preparation of a high-quality iron powder according to claim 1, wherein the high-tin-content tin tailing has a tin content of 0.4 wt % to 1.2 wt %, an iron content of 5 wt % to 50 wt %, an arsenic content of 0.1 wt % to 3 wt %, a lead content of 0.1 wt % to 5 wt %, and a zinc content of 0.1 wt % to 5 wt %.

3. The method for enhanced separation of metals from a high-tin-content tin tailing and preparation of a high-quality iron powder according to claim 1, wherein a mass ratio of the high-tin-content tin tailing to the first reducing agent is 100:(5-15).

4. The method for enhanced separation of metals from a high-tin-content tin tailing and preparation of a high-quality iron powder according to claim 1, wherein the reducing agent A has a particle size of less than 150 mesh; and the reducing agent B comprises a coarse fraction with a particle size of 50 mesh to 120 mesh and a fine fraction with a particle size of 200 mesh to 400 mesh, and a mass ratio of the coarse fraction to the fine fraction is (20-70):(80-30).

5. The method for enhanced separation of metals from a high-tin-content tin tailing and preparation of a high-quality iron powder according to claim 1, wherein the second reducing agent has a particle size of 200 mesh to 2.5 cm.

6. The method for enhanced separation of metals from a high-tin-content tin tailing and preparation of a high-quality iron powder according to claim 1, wherein the roasting residue is ground to a particle size of less than 200 mesh, and the magnetic separation is conducted at a magnetic field intensity of 70 kA/m to 140 kA/m.

7. The method for enhanced separation of metals from a high-tin-content tin tailing and preparation of a high-quality iron powder according to claim 1, wherein the high-quality iron powder has an iron grade of greater than 98%.
